(19) United States
(12) Patent Application Publication
(10) Pub. No.: US 2014/0185954 A1
(43) Pub. Date: Jul. 3, 2014

(54) INFLUENCE-BASED SOCIAL MEDIA INTERVENTIONS IN HEALTHCARE

(71) Applicants: INTERNATIONAL BUSINESS MACHINES CORPORATION, Armonk, NY (US); INDUSTRIAL TECHNOLOGY RESEARCH INSTITUTE, Hsinchu (TW)

(72) Inventors: Mark JH Hsiao, Taipei (TW); Yue-Min Jiang, Hsinchu (TW); June-Ray Lin, Taipei (TW); Alfred SH Tzao, Hsinchu (TW); Xinxin Zhu, Yorktown Heights, NY (US)

(73) Assignees: Industrial Technology Research Institute, Hsinchu (TW); International Business Machines Corporation, Armonk, NY (US)

(21) Appl. No.: 13/729,455

(22) Filed: Dec. 28, 2012

(51) Int. Cl. H04L 29/06; G06T 5/00

(52) U.S. Cl. CPC H04L 65/403; G06T 5/003
USPC 382/264; 709/204; 707/737

(57) ABSTRACT

A method for matching social network participants includes receiving activity data pertaining to a plurality of participants in a social network. The activity data is parsed to generate activity pattern summaries for each of the participants. The participants are clustered into a plurality of groups according to the activity pattern summaries. At least one participant of influence is determined within at least one group according to the activity data. A social connection is established within the social network between the determined participant of influence and at least one other participant clustered into the same group.

### TECHNICAL FIELD

The present disclosure relates to interventions in healthcare and, more specifically, to methods and systems for influence-based social media interventions in healthcare.

### DISCUSSION OF THE RELATED ART

Modem times have brought many advances in the understanding and treatment of various ailments. It is now well understood that living a healthy lifestyle involving proper nutrition, sufficient activity, and avoidance of exposure potentially harmful substances is key, not only for improving overall health, but also to significantly reduce risk factors for acquiring particular diseases.

One aspect of maintaining a healthy lifestyle that is of particular significance is the maintenance of a healthy body weight. Obesity has been linked to many diseases such as diabetes, heart disease, cancer, infertility, and back pain.

However, despite this understanding, assuring patient compliance with recommended lifestyle changes remains a difficult prospect that has received comparatively little technological attention.

Various technologies have been developed for tracking patient activity. For example, pedometers and motion detectors have been incorporated into watches and footwear. Prescribed medical devices may collect important health-related data. Patients have also been asked to furnish data pertaining to their daily food intake, experience of symptoms, and other information relating to healthcare compliance. Data from these devices, records, and various other sources may then be electronically transmitted to a healthcare provider or data processing service for the purposes of tracking and/or sending alerts.

However, despite the increasing ability to collect and monitor patient compliance, there is still a significant need for advances in the field of ensuring patient compliance to recommended lifestyle changes.

### SUMMARY

A method for matching social network participants includes receiving activity data pertaining to a plurality of participants in a social network. The activity data is parsed to generate activity pattern summaries for each of the participants. The participants are clustered into a plurality of groups according to the activity pattern summaries. At least one participant of influence is determined within at least one group according to the activity data. A social connection is established within the social network between the determined participant of influence and at least one other participant clustered into the same group.

The activity data may include a list of physical activities and a frequency by which each of the physical activities was performed by each of the participants over a predetermined period of time.

Generating the activity pattern summaries may include creating a matrix for each participant including a listing of the physical activities and a colored box corresponding to each of the physical activities for each day of the week. A shade of the colored box may correspond to a frequency by which each of the physical activities was performed by each of the participants over a predetermined period of time.

Each matrix may be a heat map.

Clustering each of the participants into a plurality of groups may include determining a Euclidian point for each activity pattern summary, calculating a Euclidian distance between each of the Euclidian points, and clustering the participants based on the distances.

The clustering may be performed using additional information pertaining to the participants that is not activity data. The additional information may include biographical information, medical information, or social network profile information pertaining to the participants.

Clustering each of the participants into a plurality of groups may include determining an energy for each activity pattern summary and clustering the participants based on the determined energy.

Clustering each of the participants into a plurality of groups may include creating an image file for each activity pattern summary, applying a low-pass filter to each image file, measuring image similarity between pairs of the filtered image files, and clustering the participants based on the measured image similarities.

Determining at least one participant of influence may include calculating a level of activity for each of the participants based on corresponding activity data, determining which of the participants have a level of activity that is above a predetermined threshold, and selecting those participants having a level of activity above the predetermined threshold as a potential participant of influence. Determining at least one participant of influence may further include determining an extent of influence for each of the potential participant of influence and selecting the participant of influence from among the potential participant of influence according to the determined extent of influence. The extent of influence may be calculated by identifying an extent to which changes in the activity pattern summaries for other participants within a given group follow similar changes within the activity pattern summaries of the potential participant of influence. Calculating the extent of influence may include examining a number of event invitations and event invitation acceptances that exist for each of the potential participants of influence within the social network.

Establishing the social connection within the social network between the determined participant of influence and at least one other participant clustered into the same group may include generating a friend request to add the determined participant of influence to a set of friends of the at least one other participant, generating a friend request to add the at least one other participant to a set of friends of the determined participant of influence, receiving a friend request acceptance from both the determined participant of influence and the at least one other participant, adding the determined participant of influence to the set of friends of the at least one other participant, and adding the at least one other participant to a set of friends of the determined participant of influence.

Establishing a social connection within the social network between the determined participant of influence and at least one other participant clustered into the same group may include generating an interaction reward table to encourage the social connection.

Establishing a social connection within the social network between the determined participant of influence and at least one other participant clustered into the same group may include sorting social network messages to prioritize messages between the determined participant of influence and the at least one other participant clustered into the same group.

A computer program product for matching social network participants includes a computer readable storage medium having program code embodied therewith. The program code is readable/executable by a computer to receive activity data pertaining to a plurality of participants in the social network, parse the activity data to generate activity pattern summaries for each of the participants, cluster each of the participants into a plurality of groups according to the activity pattern summaries, determine at least one participant of influence within at least one group according to the activity data, and establish a social connection within the social network between the determined participant of influence and at least one other participant clustered into the same group.

The activity data may include a list of physical activities and a frequency by which each of the physical activities was performed by each of the participants over a predetermined period of time.

The clustering of each of the participants into a plurality of groups may include determining a Euclidian point for each activity pattern summary, calculating a Euclidian distance between each of the Euclidian points, and clustering the participants based on the distances.

Generating the activity pattern summaries may include creating a matrix for each participant including a listing of the physical activities and a colored box corresponding to each of the physical activities for each day of the week. A shade of the colored box may correspond to a frequency by which each of the physical activities was performed by each of the participants over a predetermined period of time.

Clustering each of the participants into a plurality of groups may include determining an energy for each activity pattern summary and clustering the participants based on the determined energy.

Clustering each of the participants into a plurality of groups may include creating an image file for each activity pattern summary, applying a low-pass filter to each image file, measuring image similarity between pairs of the filtered image files, and clustering the participants based on the measured image similarities.

Determining at least one participant of influence may include calculating a level of activity for each of the participants based on corresponding activity data, determining which of the participants have a level of activity that is above a predetermined threshold, selecting those participants having a level of activity above the predetermined threshold as a potential participant of influence, determining an extent of influence for each of the potential participant of influence, and selecting the participant of influence from among the potential participant of influence according to the determined extent of influence.

Establishing the social connection within the social network between the determined participant of influence and at least one other participant clustered into the same group may include generating a friend request to add the determined participant of influence to a set of friends of the at least one other participant, generating a friend request to add the at least one other participant to a set of friends of the determined participant of influence, receiving a friend request acceptance from both the determined participant of influence and the at least one other participant, adding the determined participant of influence to the set of friends of the at least one other participant, and adding the at least one other participant to a set of friends of the determined participant of influence.

A system for matching participants within a social network includes an activity data database for providing activity data pertaining to a plurality of participants in the social network. An activity summary constructor device parses the activity data, generates activity pattern summaries for each of the participants, and clusters each of the participants into a plurality of groups according to the activity pattern summaries. A viral properties calculation device determines at least one participant of influence within at least one group according to the activity data. A social network improver establishes a social connection within the social network between the determined participant of influence and at least one other participant clustered into the same group.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating an approach for performing influence-based social media intervention in accordance with exemplary embodiments of the present invention;

FIG. 2 is an illustration of an activity summary in accordance with exemplary embodiments of the present invention;

FIG. 3 is a schematic diagram illustrating a system for performing influence-based social media interventions in healthcare in accordance with exemplary embodiments of the present invention; and

FIG. 4 shows an example of a computer system capable of implementing the method and apparatus according to embodiments of the present disclosure.

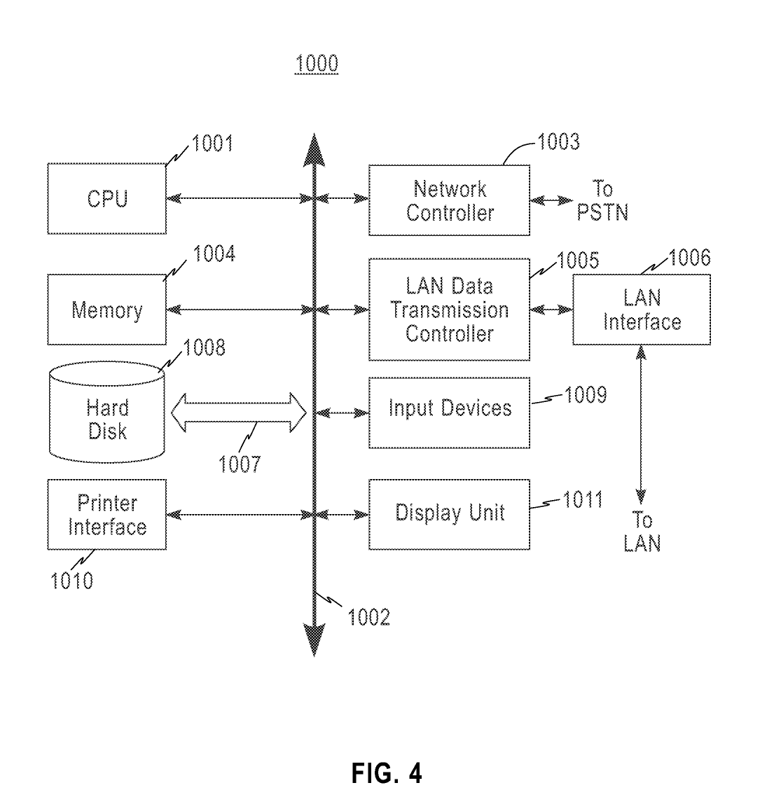

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide methods and systems for aiding and enhancing patient compliance to lifestyle changes recommended by physicians, including, but not limited to, proper nutrition, body weight management, exercise, compliance to pharmaceutical and physiotherapy regiments, and the like.

Exemplary embodiments of the present invention rely upon an understanding that patients' social circles are often highly influential on patient compliance. Accordingly, exemplary embodiments of the present invention seek to leverage new and existing social media services to implement changes to patients' social circles and to accordingly influence a degree of patient compliance. This may be done, for example, by parsing pertinent data to identify one or more people that are likely to be effective motivators of positive change for the particular patient and then to connect the patient and the motivators over a social network so that positive influence may be provided. Determining effective motivators may then become a key task. While online content may be crawled and monitored for this purpose, exemplary embodiments of the present invention may make use of activity records for individuals.

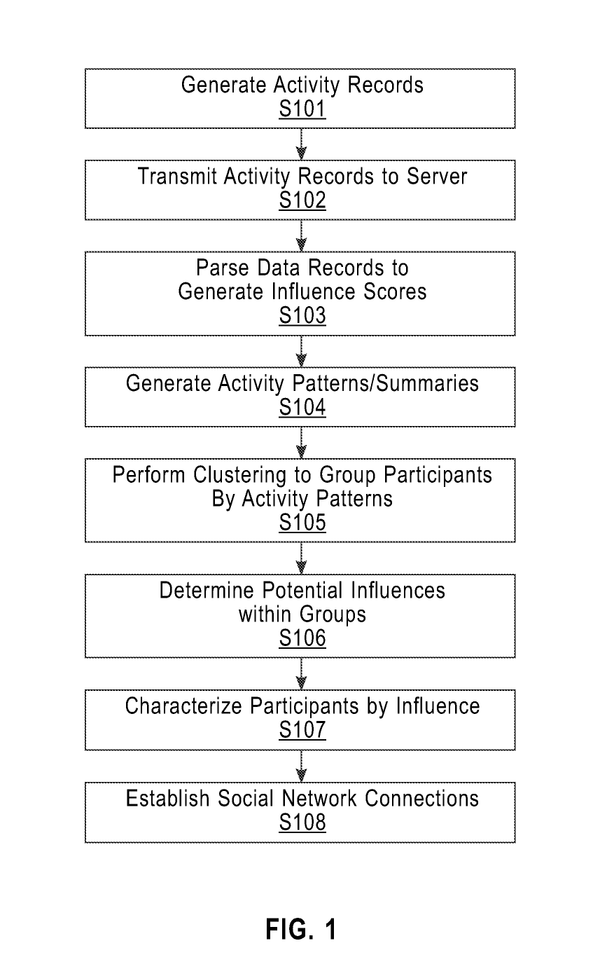

FIG. 1 is a flow chart illustrating an approach for performing influence-based social media intervention in accordance with exemplary embodiments of the present invention.

As used herein, activity records may include electronic data pertaining to an individual's physical activity as performed throughout the day. First, activity records may be generated from a plurality of different people (Step S101). Activity records may be generated from manual entry and/or from data acquired by activity monitoring devices such as accelerometers, pedometers, global positioning service (GPS) devices, whether they are embodied in wearable devices or smartphones.

Alternatively, or additionally, individuals may contribute various other forms of health data such as body weight, blood sugar levels, daily food consumption, pharmaceutical compliance data, etc.

These data records may be collected either by manual input or by direct electronic monitoring. The generated activity records may then be transmitted to a data processing device such as a computer server or other computerized system (Step S102). The computer server need not be located in a single location and may, for example, be a distributed computer server spread out over multiple computer systems and/or multiple locations. An electronic portal such as a website or a smartphone application may be used to transmit the data records to the data processing device. The transmission may occur over a private network or the Internet. The data records may be securely transmitted, for example, by using Transport Layer Security (TLS), Secure Sockets Layer (SSL), and/or a virtual private network (VPN).

The data records so acquired and transmitted may involve, not only the information of a patient of interest, but also of one or more other people engaged in tracking their activity and/or other health/compliance data. These people may be enticed to participate in the information acquisition and transmission either for the purposes of tracking health progress within a specially-formed social media environment and/or exemplary embodiments of the present invention may be tied into existing social media environments where participants may have an existing desire to share their progress.

The server receiving the data records may then parse the data records to determine two key elements. The first key element is a determination of influence. Accordingly, the data records may be parsed to generate influence scores for each individual that has contributed data (Step S103). The influence score may be indicative of a particular person's ability to persuade or lead other people. The second key element is a determination of activity pattern. Accordingly, the data records may be parsed to generate activity patterns for each individual that has contributed data (Step S104). Each activity pattern may be an expression of a pattern of behavior exhibited by the particular person. The activity pattern may be suitable for use in matching activity patterns of multiple people to determine similarity therebetween. The activity pattern may be limited only to activity data but it may also include the other pertinent data discussed above.

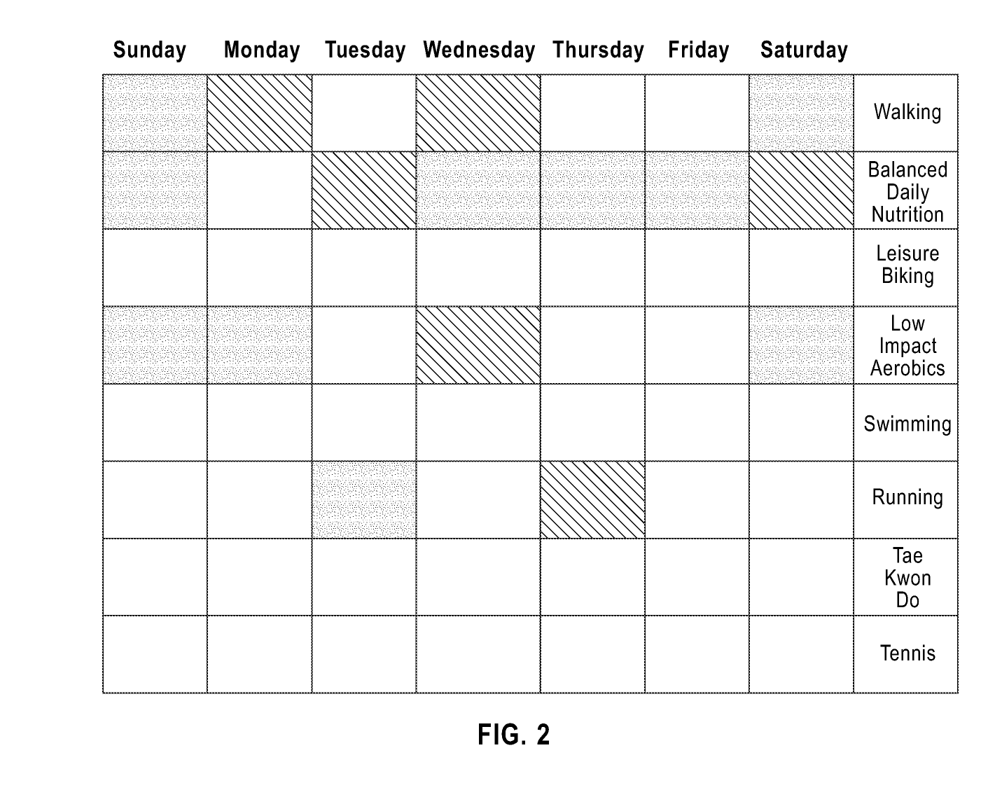

The activity pattern may be expressed, for example, as an activity summary in which each tracked activity is listed and corresponding frequency of performance provided. The frequency of performance may be broken down by days of the week. FIG. 2 is an illustration of an activity summary in accordance with exemplary embodiments of the present invention. Here, the frequency of performance is illustrated by the shade of the corresponding boxes, where the white boxes indicate lack of activity and the darkest boxes indicate a greatest extent of activity. The gray boxes accordingly represent an intermediate extent of activity. While FIG. 2 is shown as having only three distinct shades, i.e., black, white and gray, it is to be understood that there may be any number of different shades in use, which each shade representing a different level of activity. Each box may represent a specific day or an average for that day of the week over a predetermined length of time, such as three months.

Clustering techniques may then be used to group participants by activity patterns (Step S105). While matched participants may exhibit different levels of activity, there may still be sufficient commonality in the types of activities performed, the days/timing on which the activities are performed, and the relative levels of activity performance to support the clustering. Additional information may be used to support clustering and this additional information may be unrelated to activity data. For example, clustering may take into account general biographic information. This additional information may be provided by the participants as part of a registration process and/or as part of a social media profile.

As the activity summaries may be graphically represented, for example, as discussed above, various image processing techniques may be used to aid in matching similar activity summaries by image-based similarity measurement techniques. While the activity summary tables exhibit image-like characteristics when considering the rows thereof, i.e., the Sunday, Monday, Tuesday, etc. information, the columm information, i.e., the walking, swimming, running, etc. is not image-like. Accordingly, a low-pass filter may be applied to the activity summary table images on the rows data prior to performing image-based matching.

To facilitate image-based matching, the activity summary tables may be arranged as “heat maps.” A heat map is a graphical representation of data where the individual values contained in a matrix are represented as colors. Not only does the heat map arrangement facilitate image-based matching but also it may help an observer to more easily recognize compliance and areas of interest.

The heat map activity summaries may be analyzed in terms of “energies” for each activity. Where a first participant is represented by an integer i, the energy of each activity (“mission m”) may be represented as eᵢ(m) over the set of activities m₁, m₂, m₃, m₄, etc. Thus, the similarity between the activity summaries of two participants i and j, may be measured as the Euclidean distance between point (eᵢ(m₁), eᵢ(m₂), eᵢ(m₃), . . . ) and point (eⱼ(m₁), eⱼ(m₂), eⱼ(m₃), . . . ).

The above-described approach may be thought of as a mission-by-mission similarity distance approach. Another approach is a category-by-category similarity distance approach. Here, for participants i and j, with missions of a categories, an average weekly activity energy Eᵢ(c) of a category c represents an average weekly experience/calories increase of the category c. The activity similarity distance of the two participants may be defined as dist(i,j), the Euclidian distance of the points (Eᵢ(c₁), Eᵢ(c₂), Eᵢ(c₃), . . . ) to (Eⱼ(c₁), Eⱼ(c₂), Eⱼ(c₃), . . . ).

According to another approach, exercise energy similarity distances may be calculated to establish similarity. Here, for a user i, with all m exercise missions, average weekly exercise energy may be equal to an average weekly summation of m-mission calories, εᵢ. The exercise energy similarity distance between two persons i and j is |εᵢ−εⱼ|.

As discussed above, activity similarity analysis may include applying a low-pass filter to the activity summary image to filter out high-frequency waves, for example, using a Fourier transform. Each of the above-described distances may be calculated for each set of participant data. For example, for user i, average weekly activity energy pattern pᵢ(m) of a mission is defined as a vector [e₁, e₂, e₃, e₄, e₅, e₆, e₇] of average day-of-week experience/calories increase of the mission M. The average similarity distance of two users i and j is defined as the Euclidian distance between points (pᵢ(m₁), pᵢ(m₂), pᵢ(m₃), . . . ) and (pⱼ(m₁), pⱼ(m₂), pⱼ(m₃), . . . ). Here |(pᵢ(m₁)−(pⱼ(m₁)| may be defined as the Euclidean distance of the two vectors.

With respect to the category-by-category similarity distance, for users i and j, with missions of n categories, an average weekly activity energy pattern Pᵢ(c) defined as a vector [e₁, e₂, e₃, e₄, e₅, e₆, e₇] of average day-of-week experience/calories increase of the category c. The activity similarity distance of the two users i and j, dist(i,j), is defines as the Euclidian distance between point (Pᵢ(c₁), Pᵢ(c₂), Pᵢ(c₃), . . . ) and (Pⱼ(c₁), Pⱼ(c₂), Pⱼ(c₃), . . . ). Here |(Pᵢ(c₁)−(Pⱼ(c₁)| may be defined as the Euclidean distance of the two vectors (Pᵢ(c₁) and Pⱼ(c₁).

Influence may also be determined from the activity records. For example, where changes in activity summaries for one particular participant tend to be followed by similar changes in activity summaries for other participants, the first participant may be given a relatively high influence score.

Another factor in calculating influence would be to analyze activity invitations. Social media platforms may provide means for participants to send invitations to other participants to attend or otherwise participate in activities such as athletic competitions and events. The sending of such invitations may be used to increase influence scores and additionally, the number of participants that accept the invitations may also be highly pertinent.

The activity records data and/or the influence scores may then be used to determine a set of one or more potential influencers (Step S106). For example, an energy score may be calculated form the activity summaries of the participants based on the density of darker squares. The energy score may also be calculated directly from the activity data and may indicate a level of activity intensity. Potential influencers may be those participants that meet a predetermined intensity threshold. The intensity threshold may be set either by reasoned analysis or by statistical review of the activity data for multiple participants. While the influence score may be considered in finding potential influencers, it may also be excluded from this analysis.

Exemplary embodiments of the present invention recognize that not all participants that meet the activity threshold may be suitable influencers. Accordingly, exemplary embodiments of the present invention seek to distinguish between high performers that do not tend to influence other's (“champions”) and those that may influence other (“leaders”).

For this reason, influence scores may then be used to characterize each participant meeting the activity threshold as either a champion or a leader (Step S107). A social connection may then be established between a participant/patient and an influencer that have been found to be within the same activity cluster (Step S108). The social connection may include the automatic generation of a friend/follow request that may then be manually approved by one or both participants or the friend/follow relationship may be automatically established. From that point forward, the participant/patient may benefit from the influence of the leader. Multiple participant/patients may be so linked to a given leader and multiple leaders may be so linked to a given participant patient. While no reward need be offered to either the participant/patients or the leader, rewards may be used to enhance interaction between linked participants/patients and leaders.

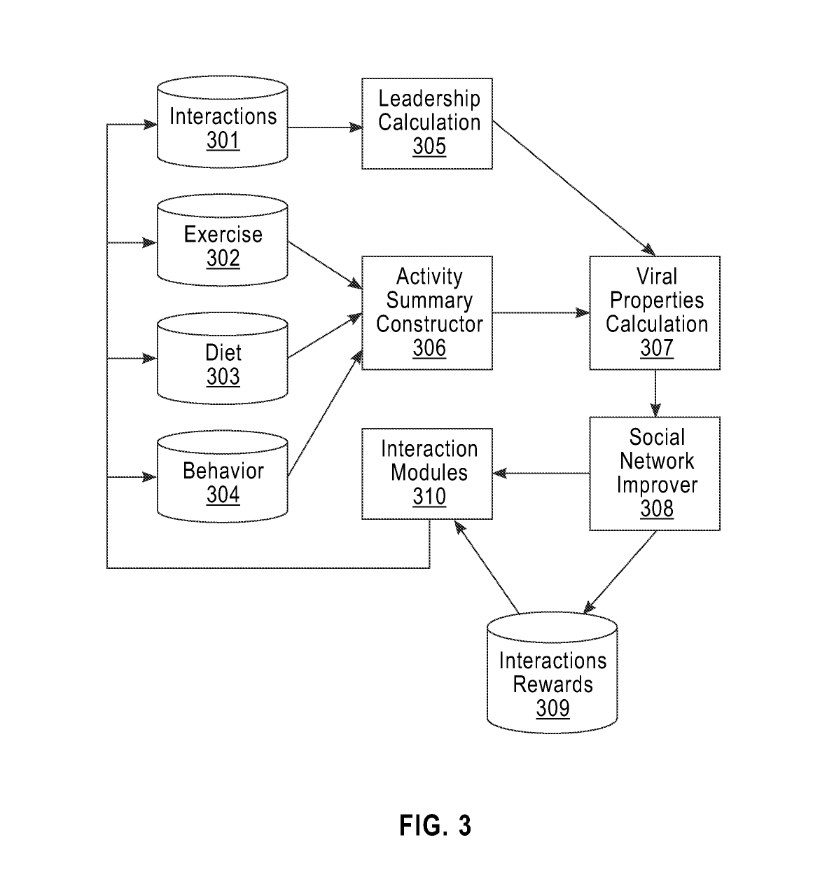

FIG. 3 is a schematic diagram illustrating a system for performing influence-based social media interventions in healthcare in accordance with exemplary embodiments of the present invention. An interactions database 301 be used to store data pertaining to system participants and the various social interactions that may transpire between them such as likes, messages, comments, invitations sent and accepted, etc. An exercise database 302 may be used to store information pertaining to the participant's activity data. A diet database 303 may be used to store information pertaining to the foods consumed by the participants. A behavior database 304 may be used to store other pertinent information pertaining to lifestyle behavior that may influence health such as smoking and drinking habits, stress minimizing techniques, adherence to pharmaceutical regiment, etc.

Of course several of the above-described databases may be embodied as a single database or one of the above-described databases may be divided across databases.

The interaction database 301 may provide information that may be used by a leadership calculation device 305 to determine a leadership score, for example, in the manner described above. The exercise database 302, the diet database 303 and the behavior database 304 may all be accessed by an activity summary constructor device 306 which may use the information to build the activity summaries described above. The output from the leadership calculation device 305 and the activity summary constructor device 306 may be used by a viral properties calculation device 307 to cluster the participants and to determine who the leaders are within each of the clusters.

This information may then be used by a social network improver device 308 to determine which participants would best be matched with which leaders. These matches may then be sent both to an interaction rewards database 309 and an interaction modules device 310. The interaction rewards database 309 may store information pertaining to the quality of each participant's set of associations as assessed by the social network improver 308. These associations may be confirmed friends/followers within the social network, e.g. participants with relationships between them that are recorded and presented within the social network. The quality of these associations may be measured in terms of the number of friends/followers that are leaders with respect to that participant. The social network improver device 308 seeks to increase the quality of each participant by determining the associations to make.

The interactions rewards database 309 may also provide the interaction modules device 310 with the quality scores for each participant's set of friends/followers. The interaction modules device 310 may carryout the formation of new relationships, for example, by generating friend-requests and providing the participants/leaders with the opportunity to accept the requests, thereupon the new relationships may be formed.

Each of the above-identified devices 305, 306, 307, 308, and 310 may be embodied within one or more computer systems such as a computer server. A social network utilizing the methods and systems described above may be specifically designed around promotion of good health or may be integrated into existing popular social media networks. Participants may be encouraged to participate and contribute their information in exchange for various rewards or as a competition. The social network may also facilitate interaction among participants, and in particular, may allow for the generation and acceptance of online invitations to events.

A participant wishing to improve his or her conformance to a more healthful lifestyle may initiate the above-described approaches, for example, by activating a healthy social network filter offered by the system. This filter may later be disabled at the request of the user.

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for matching social network participants, comprising:
receiving activity data pertaining to a plurality of participants in said social network;
parsing said activity data to generate activity pattern summaries for each of said participants;
clustering each of said participants into a plurality of groups according to said activity pattern summaries;
determining at least one participant of influence within at least one group according to said activity data; and
establishing a social connection within said social network between the determined participant of influence and at least one other participant clustered into the same group.

2. The method of claim 1, wherein said activity data comprises a list of physical activities and a frequency by which each of the physical activities was performed by each of said participants over a predetermined period of time.

3. The method of claim 1, wherein generating said activity pattern summaries includes creating a matrix for each participant including a listing of said physical activities and a colored box corresponding to each of said physical activities for each day of the week wherein a shade of said colored box corresponds to a frequency by which each of the physical activities was performed by each of said participants over a predetermined period of time.

4. The method of claim 3, wherein each matrix is a heat map.

5. The method of claim 1, wherein clustering each of said participants into a plurality of groups includes:
determining a Euclidian point for each activity pattern summary;
calculating a Euclidian distance between each of said Euclidian points; and
clustering said participants based on said distances.

6. The method of claim 1, wherein said clustering is performed using additional information pertaining to said participants that is not activity data.

7. The method of claim 6, wherein said additional information includes biographical information, medical information, or social network profile information pertaining to said participants.

8. The method of claim 1, wherein clustering each of said participants into a plurality of groups includes:
determining an energy for each activity pattern summary; and
clustering said participants based on said determined energy.

9. The method of claim 1, wherein clustering each of said participants into a plurality of groups includes:
creating an image file for each activity pattern summary;
applying a low-pass filter to each image file;
measuring image similarity between pairs of said filtered image files; and
clustering said participants based on said measured image similarities.

10. The method of claim 1, wherein determining at least one participant of influence includes:
calculating a level of activity for each of said participants based on corresponding activity data;
determining which of said participants have a level of activity that is above a predetermined threshold; and
selecting those participants having a level of activity above said predetermined threshold as a potential participant of influence.

11. The method of claim 10, wherein determining at least one participant of influence further includes:
determining an extent of influence for each of said potential participant of influence; and
selecting said participant of influence from among the potential participant of influence according to said determined extent of influence.

12. The method of claim 11, wherein said extent of influence is calculated by identifying an extent to which changes in said activity pattern summaries for other participants within a given group follow similar changes within said activity pattern summaries of said potential participant of influence.

13. The method of claim 11, wherein calculating said extent of influence includes examining a number of event invitations and event invitation acceptances that exist for each of said potential participants of influence within said social network.

14. The method of claim 1, wherein establishing said social connection within said social network between the determined participant of influence and at least one other participant clustered into the same group comprises:
generating a friend request to add the determined participant of influence to a set of friends of said at least one other participant;
generating a friend request to add the at least one other participant to a set of friends of said determined participant of influence;
receiving a friend request acceptance from both the determined participant of influence and the at least one other participant;
adding said determined participant of influence to the set of friends of said at least one other participant; and
adding said at least one other participant to a set of friends of said determined participant of influence.

15. The method of claim 1, wherein establishing a social connection within said social network between the determined participant of influence and at least one other participant clustered into the same group includes generating an interaction reward table to encourage the social connection.

16. The method of claim 1, wherein establishing a social connection within said social network between the determined participant of influence and at least one other participant clustered into the same group includes sorting social network messages to prioritize messages between the determined participant of influence and the at least one other participant clustered into the same group.

17. A computer program product for matching social network participants, the computer program product comprising a computer readable storage medium having program code embodied therewith, the program code readable/executable by a computer to:
receive activity data pertaining to a plurality of participants in said social network;
parse said activity data to generate activity pattern summaries for each of said participants;
cluster each of said participants into a plurality of groups according to said activity pattern summaries;
determine at least one participant of influence within at least one group according to said activity data; and
establish a social connection within said social network between the determined participant of influence and at least one other participant clustered into the same group.

18. The computer program product of claim 17, wherein said activity data comprises a list of physical activities and a frequency by which each of the physical activities was performed by each of said participants over a predetermined period of time.

19. The computer program product of claim 17, wherein clustering each of said participants into a plurality of groups includes:
determining a Euclidian point for each activity pattern summary;
calculating a Euclidian distance between each of said Euclidian points; and
clustering said participants based on said distances.

20. The computer program product of claim 17, wherein generating said activity pattern summaries includes creating a matrix for each participant including a listing of said physical activities and a colored box corresponding to each of said physical activities for each day of the week wherein a shade of said colored box corresponds to a frequency by which each of the physical activities was performed by each of said participants over a predetermined period of time.

21. The computer program product of claim 17, wherein clustering each of said participants into a plurality of groups includes:
determining an energy for each activity pattern summary; and
clustering said participants based on said determined energy.

22. The computer program product of claim 17, wherein clustering each of said participants into a plurality of groups includes:
creating an image file for each activity pattern summary;
applying a low-pass filter to each image file;
measuring image similarity between pairs of said filtered image files; and
clustering said participants based on said measured image similarities.

23. The computer program product of claim 17, wherein determining at least one participant of influence includes:
calculating a level of activity for each of said participants based on corresponding activity data;
determining which of said participants have a level of activity that is above a predetermined threshold;
selecting those participants having a level of activity above said predetermined threshold as a potential participant of influence;
determining an extent of influence for each of said potential participant of influence; and
selecting said participant of influence from among the potential participant of influence according to said determined extent of influence.

24. The computer program product of claim 17, wherein establishing said social connection within said social network between the determined participant of influence and at least one other participant clustered into the same group comprises:
generating a friend request to add the determined participant of influence to a set of friends of said at least one other participant;
generating a friend request to add the at least one other participant to a set of friends of said determined participant of influence;
receiving a friend request acceptance from both the determined participant of influence and the at least one other participant;
adding said determined participant of influence to the set of friends of said at least one other participant; and
adding said at least one other participant to a set of friends of said determined participant of influence.

25. A system for matching participants within a social network, comprising:
an activity data database for providing activity data pertaining to a plurality of participants in said social network;
an activity summary constructor device for parsing said activity data, generating activity pattern summaries for each of said participants, and clustering each of said participants into a plurality of groups according to said activity pattern summaries;
a viral properties calculation device for determining at least one participant of influence within at least one group according to said activity data; and
a social network improver for establishing a social connection within said social network between the determined participant of influence and at least one other participant clustered into the same group.
